(19) United States
(12) Patent Application Publication
(10) Pub. No.: US 2013/0132377 A1
(43) Pub. Date: May 23, 2013

(54) Systems and Methods for Localized Bag-of-Features Retrieval

(71) Applicants: Zhe Lin, Santa Clara, CA (US); Jonathan W. Brandt, Santa Cruz, CA (US)

(72) Inventors: Zhe Lin, Santa Clara, CA (US); Jonathan W. Brandt, Santa Cruz, CA (US)

(21) Appl. No.: 12/869,460

(22) Filed: Aug. 26, 2010

(51) Int. Cl. G06F 17/30

(52) U.S. Cl. 707/723; 707/737; 707/E17.014; 707/E17.089

(57) ABSTRACT

Methods and systems for performing fast, large-scale, localized Bag-of-Features (Local BoF) retrieval are disclosed. In some embodiments, a method may include receiving a query image and ranking each image of a large set of database images as a function of its similarity to the query image with a Local BoF operation. A Local BoF operation may be configured to localize, for each ranked image, a region that has a highest similarity to the query image. As such, the systems and methods described herein may be suitable for use in large-scale image search and retrieval or categorization operations that may identify objects of interest with arbitrary rotations, significantly different viewpoints, in the presence of clutter. In some embodiments, systems and methods described herein may be used as building blocks of various computer vision and image processing applications including, for example, object recognition and categorization, 3D modeling, mapping, navigation, gesture interfaces, etc.

### BACKGROUND

1. Field of the Invention

This specification relates to computer imaging and vision, and, more particularly, to systems and methods for performing fast, large-scale, localized Bag-of-Features (Local BoF) retrieval.

2. Description of the Related Art

Conventional bag-of-features (BoF) algorithms are well-established in image and video retrieval applications. These algorithms typically receive a query image and then attempt to find similar images within a database of images.

A conventional BoF algorithm first extracts feature descriptors from each image. For example, a suitable feature descriptor may be a Scale-Invariant Feature Transform (SIFT) descriptor or the like. A clustering process then uniquely maps each feature descriptor to a cluster center or “visual word.” After the clustering operation, each image is represented by a histogram that indicates the number of occurrences of each visual word in the whole image. The algorithm then produces a list indicating which database images more closely match the query image. The list may be ranked according to a metric calculated based on a comparison between histograms of the query and database images.

Actually locating objects of interest within each ranked image, however, usually requires additional and computationally intensive post-processing operations. These operations typically aim to verify the spatial consistency of the retrieved images, and may involve applying techniques such as, for example, spatial neighborhood counting, Random Sample Consensus (RANSAC)-based spatial matching, or the like.

Spatial neighborhood counting uses the total number of neighboring word correspondences to “re-rank” the images previously ranked by the BoF matching. This particular post-processing technique is largely dependent on the size of the “neighborhood,” and is not capable of capturing spatial relationships in wide configurations. Meanwhile, RANSAC-based post-processing is typically limited to near planar objects, and can only be applied to a relatively small number of images at a time due to its complexity. Also, these RANSAC-based routines often result in a significant computational cost that effectively limits the total number of images that can be processed.

### SUMMARY

This specification is related to computer image and vision technologies. Certain embodiments of methods and systems disclosed herein may provide localized Bag-of-Features (Local BoF) techniques that may be suitable for use in image retrieval, categorization, or the like. In some embodiments, techniques may provide a Local BoF framework to support scalable local matching that may identify objects of interest with arbitrary rotations, significantly different viewpoints, in the presence of clutter, and without post-processing operations. As such, these techniques may be used as the building blocks of various computer vision and image processing applications including, for example, object recognition and categorization, 3D modeling, mapping, navigation, gesture interfaces, etc.

An illustrative Local BoF image retrieval method as described herein may identify the location of regions or sub-regions in images that have a certain degree of similarity with respect to a query image. For example, a Local BoF representation of an image may include a set of histograms, where each histogram depends upon a bounding region within the image. A bounding region may have any suitable geometric shape. For instance, in certain embodiments, each image may be represented as a BoF histogram parameterized by a “subrectangle”—i.e., a rectangle within the image.

In some embodiments, a BoF representation is calculated for a query image. Then a local matching procedure may be performed to match the BoF representation of the query image (or a sub-region thereof) to one or more Local BoF representations—i.e., regions or sub-regions—of one or more database images.

In certain embodiments, bounding regions whose corresponding local histograms optimize query relevance may be identified as part of an image retrieval process, and images may be ranked accordingly. These embodiments may accomplish local histogram matching and object localization simultaneously by implicitly encoding spatial constraints during the retrieval process with low computational overhead.

Some embodiments may employ spatial quantization-based indexing mechanisms to compute sparse feature frequencies or energies “offline”—i.e., prior to executing a query—and compute similarities to the query over a grid of rectangles “online”—i.e., at query time. A spatial quantization-based indexing mechanism may involve, for example, the use of a fast inverted file or index. Furthermore, intermediate structures such as integral images or summed area tables may be generated, for example, using a binary approximation of the Local BoF model, and may thus allow localized similarities to be computed very efficiently. In some embodiments, two or more BoF histogram comparisons may be performed to produce a final ranking. This procedure may allow matching a query BoF histogram against a broad set of subrectangle BoF histograms for each of the database images.

In some embodiments, a Local BoF model as described herein may replace conventional BoF models in image retrieval and/or classification operations. In other embodiments, a Local BoF model as described herein may replace post-processing operations that ordinarily follow conventional BoF algorithms, thus serving as a spatial verification alternative to RANSAC-based schemes. For example, a conventional BoF operation may be used to narrow the field of database images to be processed by a Local BoF algorithm.

In yet other embodiments, a Local BoF model may be extended by imposing a weak spatial consistency constraint using a local spatial pyramid-based representation.

### BRIEF DESCRIPTION OF THE DRAWINGS

FIG. 1 is a block diagram of an illustrative computer system or device configured to implement some embodiments.

FIG. 2 is a block diagram of an illustrative image analysis module according to some embodiments.

FIG. 3 is a flowchart of an image retrieval method according to some embodiments.

FIG. 4 shows images illustrating example results obtained using a localized BoF method according to some embodiments.

FIGS. 5A-D show example results of comparisons among Local BoF, Global BoF, and Local Spatial Pyramid methods using the Oxbuild data set according to some embodiments.

FIGS. 6A and 6B shows graphs of an optimization analysis according to some embodiments.

FIGS. 7A-C show graphs of a Local BoF parameter analysis according to some embodiments.

FIGS. 8A and 8B show example results of comparisons among Local BoF, Global BoF, and LSPM using the Ukbench data set according to some embodiments.

While this specification provides several embodiments and illustrative drawings, a person of ordinary skill in the art will recognize that the present specification is not limited only to the embodiments or drawings described. It should be understood that the drawings and detailed description are not intended to limit the specification to the particular form disclosed, but, on the contrary, the intention is to cover all modifications, equivalents and alternatives falling within the spirit and scope of the claims. The headings used herein are for organizational purposes only and are not meant to be used to limit the scope of the description. As used herein, the word “may” is meant to convey a permissive sense (i.e., meaning “having the potential to”), rather than a mandatory sense (i.e., meaning “must”). Similarly, the words “include,” “including,” and “includes” mean “including, but not limited to.”

### DETAILED DESCRIPTION OF EMBODIMENTS

### Introduction

This specification first presents an illustrative computer system or device, as well as an illustrative image analysis module configured to implement certain embodiments of methods disclosed herein. The specification then discloses various Bag-of-Features (BoF) models, followed by Local BoF-based image retrieval techniques that enable fast, large-scale image searches. The last portion of the specification discusses applications where systems and methods described herein have been employed.

In the following detailed description, numerous specific details are set forth to provide a thorough understanding of claimed subject matter. However, it will be understood by a person of ordinary skill in the art in light of this specification that claimed subject matter may be practiced without necessarily being limited to these specific details. In some instances, methods, apparatuses or systems that would be known by a person of ordinary skill in the art have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

### A Computer System or Device

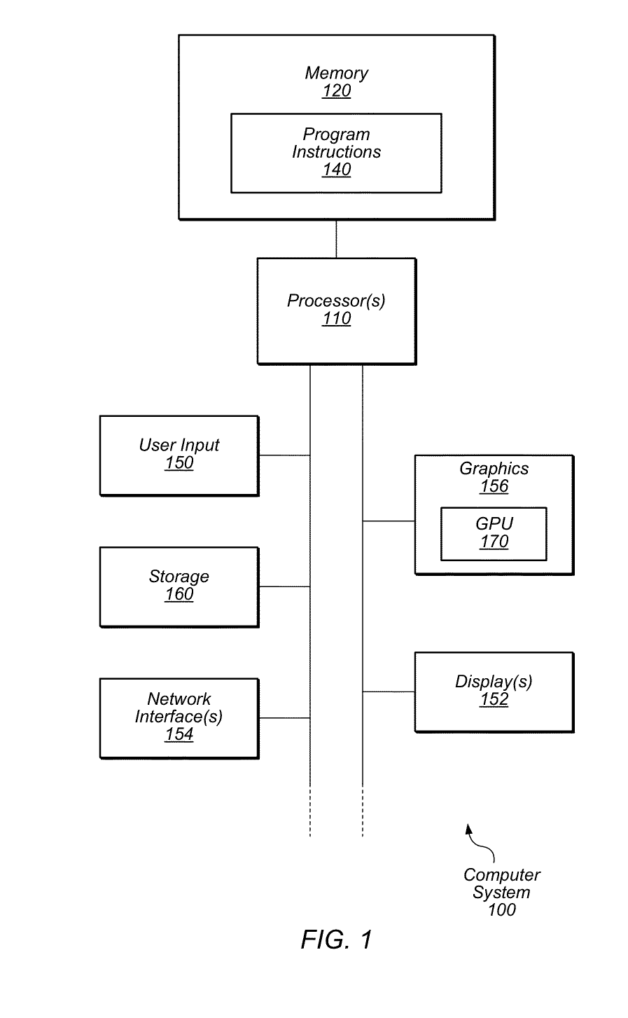

FIG. 1 is a block diagram showing elements of an illustrative computer system 100 that is configured to implement embodiments of the systems and methods described herein. The computer system 100 may include one or more processors 110 implemented using any desired architecture or chip set, such as the SPARC™ architecture, an x86-compatible architecture from Intel Corporation or Advanced Micro Devices, or an other architecture or chipset capable of processing data. Any desired operating system(s) may be run on the computer system 100, such as various versions of Unix, Linux, Windows® from Microsoft Corporation, MacOS® from Apple Inc., or any other operating system that enables the operation of software on a hardware platform. The processor(s) 110 may be coupled to one or more of the other illustrated components, such as a memory 120, by at least one communications bus.

In one embodiment, a specialized graphics card or other graphics component 156 may be coupled to the processor(s) 110. The graphics component 156 may include a graphics processing unit (GPU) 170, which in some embodiments may be used to perform at least a portion of the techniques described below. Additionally, the computer system 100 may include one or more imaging devices 152. The one or more imaging devices 152 may include various types of raster-based imaging devices such as monitors and printers. In one embodiment, one or more display devices 152 may be coupled to the graphics component 156 for display of data provided by the graphics component 156.

In one embodiment, program instructions 140 that may be executable by the processor(s) 110 to implement aspects of the techniques described herein may be partly or fully resident within the memory 120 at the computer system 100 at any point in time. The memory 120 may be implemented using any appropriate medium such as any of various types of ROM or RAM (e.g., DRAM, SDRAM, RDRAM, SRAM, etc.), or combinations thereof. The program instructions may also be stored on a storage device 160 accessible from the processor(s) 110. Any of a variety of storage devices 160 may be used to store the program instructions 140 in different embodiments, including any desired type of persistent and/or volatile storage devices, such as individual disks, disk arrays, optical devices (e.g., CD-ROMs, CD-RW drives, DVD-ROMs, DVD-RW drives), flash memory devices, various types of RAM, holographic storage, etc. The storage 160 may be coupled to the processor(s) 110 through one or more storage or I/O interfaces. In some embodiments, the program instructions 140 may be provided to the computer system 100 via any suitable computer-readable storage medium including the memory 120 and storage devices 160 described above.

The computer system 100 may also include one or more additional I/O interfaces, such as interfaces for one or more user input devices 150. In addition, the computer system 100 may include one or more network interfaces 154 providing access to a network. It should be noted that one or more components of the computer system 100 may be located remotely and accessed via the network. The program instructions may be implemented in various embodiments using any desired programming language, scripting language, or combination of programming languages and/or scripting languages, e.g., C, C++, C#, Java™, Perl, etc. The computer system 100 may also include numerous elements not shown in FIG. 1, as illustrated by the ellipsis.

### An Image Analysis Module

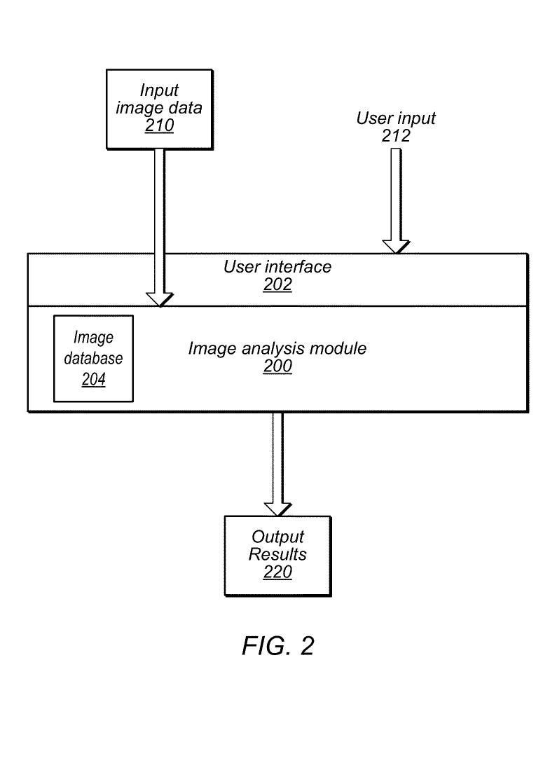

FIG. 2 shows an illustrative image analysis module that may implement certain embodiments disclosed herein. In one embodiment, module 200 may provide a user interface 202 that includes one or more user interface elements via which a user may initiate, interact with, direct, and/or control the method performed by module 200. Module 200 may be operable to obtain digital image data for a digital image 210, receive user input 212 regarding the image data, analyze the image data and/or the input, and output analysis results for the image data 220. In one embodiment, the module may include or otherwise have access to additional or auxiliary image-related information, e.g., a collection database images 204, feature descriptors, a visual vocabulary, etc., as will be discussed in detail below. Further details regarding the functionality provided by the module 200 are discussed below. It is noted that in some embodiments, database images 204 may be stored separately from module 200.

Image analysis module 200 may be implemented as (or within) a stand-alone application or as a module of or plug-in for an image processing application. Examples of types of applications in which embodiments of module 200 may be implemented may include, but are not limited to, image (including video) analysis, characterization, search, processing, and/or presentation applications, as well as applications in security or defense, educational, scientific, medical, publishing, digital photography, digital films, games, animation, marketing, and/or other applications in which digital image analysis, characterization, representation, or presentation may be performed. Specific examples of applications in which embodiments may be implemented include, but are not limited to, Adobe® Photoshop®, Adobe® Photoshop Elements®, Adobe® Premiere Elements®, Adobe® Lightroom®, Adobe® Premiere Pro®, and Adobe® Photoshop.com®. Module 200 may also be used to display, manipulate, modify, classify, and/or store images, for example to a memory medium such as a storage device or storage medium.

### BoF Models

This portion of the specification first describes a globalized BoF (Global BoF) model. In some embodiments, a Global BoF operation may be used to reduce the number of database images to be further processed by a localized BoF (Local BoF) algorithm. Then, a Local BoF model is disclosed according to certain embodiments. As described in more detail below, a Local BoF model may be created by applying region-based parameterization upon BoF representation of database images. In some embodiments, this region-based parameterization may effectively combine histogram matching and spatial verification operations.

Global BoF

Qualitatively speaking, a Global BoF image matching algorithm may generally be understood to treat an individual image as a collection (“bag”) of features that can be enumerated, e.g., by a set of corresponding descriptors. Thus, determining whether a query image matches a target member of a set of database images may proceed by determining how many of the features of the query image match corresponding features of the target image. (For example, the set of descriptors of the query image may be compared against the set of descriptors of a particular target database image.) In some instances, the greater the degree of correspondence between the features of the query image and the features of the target image, the greater the likelihood or quality of a match between the two.

However, in some embodiments, a Global BoF algorithm compares image features without regard for the spatial location of the various features. That is, a Global BoF algorithm may simply consider whether a feature is present or absent from an image, without considering where the feature is positioned within the image. If an image query were based solely on Global BoF feature matching, query results might be suboptimal, because two images with features in different spatial locations might be regarded as matching even though they may appear quite different. Correspondingly, in some embodiments, a spatial verification process is performed subsequent to Global BoF feature matching in order to determine whether corresponding image features also have corresponding spatial relationships within their respective images.

An example Global BoF algorithm is now examined in detail. When executed, a Global BoF algorithm produces a list of database images that most closely match a query image. To that end, the Global BoF algorithm may first detect image features and extract them as high-dimensional descriptors, such that fεRⁿ, where f is a high-dimensional descriptor Rⁿ refers to an n-dimensional space with real coordinates. Examples of high-dimensional image descriptors include the scale-invariant feature transform (“SIFT”) descriptors, Speeded Up Robust Features (“SURF”) descriptors, though other types of descriptors may be employed. In a typical case, an image may have tens or hundreds of descriptors, and each descriptor may in turn contain hundreds of dimensions or features.

Then, each of the descriptors may be quantized according to a quantization function C such that C: Rⁿ→{1, 2, 3, . . . , V} to generate a set of “visual words” representing the image. The Global BoF representation of an image is a histogram of all visual words found within the image and possibly weighted, for instance, by term frequency-inverse document frequency (TF-IDF). As used herein, “term frequency” (TF) t(i) is defined as the number of occurrences of word i in an image, whereas the term “inverse document frequency” (IDF) αᵢ is defined as:

$${α}_{i} = log \frac{N}{{N}_{i}} ,$$

where N is the total number of images and Nᵢ is the number of images containing the word i.

It should be emphasized that each Global BoF representation or histogram indicates occurrences of visual words in each whole image without regard to the spatial distribution of the features that gave rise to the visual words. With that in mind, let q denote the Global BoF histogram for a query image, and d denote the Global BoF for a database image. The similarity of d to query q may be given by the distance D(q, d):

D(q,d)=|q−d′|ₚ^{p}|,

where:

pε{1,2}|,

It may be noted that, when p=1, D(q,d) is the L₁ norm between q and d. Furthermore, when p=2, D(q,d) is the squared L₂ norm.

When performing a search, database images may be ranked, for example, in ascending order of the distance to the query image. Because BoF histograms tend to become very sparse as the number of visual words gets large, the distance D may often be evaluated more efficiently by considering only “non-zero” elements of q and d. To that end, q and d may be normalized using any suitable normalization. For example, if BoF histograms are normalized using the L₂ norm, a simplification may as follows:

$$\begin{matrix}D ( q , d ) = {‖ q - d ‖}_{2}^{2} \\ = 2 - 2 {\sum }_{i \vert {q}_{i} \neq 0 ⋀ {d}_{i} \neq 0} {q}_{i} {d}_{i} \cdot \vert\end{matrix} \qquad ( 1 )$$

And we may define the L₂ norm-based BoF similarity as:

$$S ( q , d ) := {\sum }_{i \vert {q}_{i} \neq 0 ⋀ {d}_{i} \neq 0} {q}_{i} {d}_{i} \vert \qquad ( 2 )$$

In case of L₁ norm, the elimination of zero elements may be as follows:

$$D ( q , d ) = {\vert q - d \vert \vert}_{1}^{1} = 2 - {\sum }_{i \vert {q}_{i} \neq ⋀ {d}_{i} \neq 0} ( {q}_{i} + {d}_{i} - \vert {q}_{i} - {d}_{i} \vert ) \qquad ( 3 )$$

And we may define the L₁ norm-based BoF similarity as:

$$S ( q , d ) := {\sum }_{i \vert {q}_{i} \neq 0 ⋀ {d}_{i} \neq 0} ( {q}_{i} + {d}_{i} - \vert {q}_{i} - {d}_{i} \vert ) \qquad ( 4 )$$

In any either case, the search relevance of a database image I_{d} to a query image I_{q} may be given by the BoF similarity S(I_{d}, I_{q})=S(q, d).

Local BoF

As noted above, a Global BoF algorithm considers features with regard to an image as a whole and without regard to spatial relationships. Thus, post-processing may be needed to perform spatial verification in order to determine whether the features of an image that is similar to a given query according to the Global BoF are spatially consistent with the features of the query image. By contrast, a Local BoF algorithm may operate to determine whether a particular feature of a query image corresponds to a subregion of an image (such as a subrectangle). By considering position as part of the query process, a Local BoF may not require a computationally expensive spatial verification post-processing operation, as do typical Global BoF algorithms.

In some embodiments, a Local BoF model may be created by introducing a parameterization of the Global BoF representation d for a database image. The parameterization may be based on a region or sub-region within the database image. As such, the Local BoF representation of an image may be seen as a set of histograms, where each histogram depends upon a bounding region or sub-region within the image; although in some embodiments, not all histograms need to be explicitly calculated for each bounding region of an image.

A bounding region may have any suitable geometric shape. For instance, in certain embodiments, each image may be represented as a BoF histogram parameterized by “subrectangles”—i.e., rectangles within the image—that form a grid over the image. This grid may be, for example, a “coarse” grid that effectively reduces the resolution of the image for purposes of certain calculations. In some embodiments, intermediate structures that speed up certain calculations may be defined on the grid, instead of at all pixels.

For example, let a Local BoF representation be a function d(R) of a rectangle RεR, where R is parameterized by its bounding top/bottom/left/right image coordinates (t, b, l, r), and R denotes the set of all subrectangles in an image. In this case, for any database image, and for a given subrectangle within the image, d(R) is the normalized histogram of visual words occurring inside that given subrectangle.

Image similarity may then be expressed as a global maximum of BoF similarity over the set of all possible subrectangles for the image:

$$\begin{matrix}S ( {I}_{q} , {I}_{d} ) = {max}_{R ∈ R} S ( q , d ( R ) ) , \\ {R}^{*} ( {I}_{d} ) = arg {max}_{R ∈ R} S ( q , d ( R ) ) .\end{matrix} \vert \qquad ( 5 ) and ( 6 )$$

where S(q, d(R)) is a localized object similarity and R*(I_{d}) is a detected bounding box for image I_{d}. It may be noted that, for each image, R* may not be generally unique. That is, there may be two or more rectangles that yield the same similarity metric. Accordingly, in some embodiments, a smallest rectangle among a set of rectangles of equal similarity value may be selected as the detected bounding box.

In some embodiments, equations (5) and (6) above may be solved in a naïve way by evaluating the similarity for all possible subrectangles in all images in a sliding window approach. Additionally or alternatively, the number of rectangles to be considered may be reduced by utilizing, for example, a branch-and-bound approach or the like.

In other embodiments, methods and systems described herein may produce an inverted file or index storage representation to take advantage of the sparsity of BoF vectors and achieve more efficiency. In addition, similarity equations (2) and/or (4) may be fit into an integral image computation framework by converting a sum-over-word index to sum-over-feature form, and/or by factoring a BoF normalization term out of the summation. Cases of L₁ and L₂ norm-based BoF similarity are addressed in turn below.

Consider first the case of L₂ norm. Let \tilde{q} and \tilde{d}| denote unnormalized TF-IDF weighted BoF histograms for a query and database images, respectively. Applying the L₂ norm yields: q=\tilde{q}/∥\tilde{q}∥ and d=\tilde{d}/∥\tilde{d}∥, and equation (2) may be rewritten as follows:

$$S ( q , d ) = {\sum }_{i \vert {\tilde{q}}_{i} \neq 0 ⋀ {\tilde{d}}_{i} \neq 0} \frac{{\tilde{q}}_{i} {\tilde{d}}_{i}}{‖ \tilde{q} ‖ ‖ \tilde{d} ‖} = \frac{1}{‖ \tilde{q} ‖ ‖ \tilde{d} ‖} {\sum }_{i \vert {\tilde{q}}_{i} \neq 0 ⋀ {\tilde{d}}_{i} \neq 0} {\tilde{q}}_{i} {\tilde{d}}_{i} \vert \qquad ( 7 )$$

Similarly, a localized similarity S(q, d(R)) may be written as follows:

$$S ( q , d ( R ) ) = \frac{1}{‖ \tilde{q} ‖ ‖ \tilde{d} ( R ) ‖} {\sum }_{i \vert {\tilde{q}}_{i} \neq 0 ⋀ {\tilde{d}}_{i} ( R ) \neq 0} {\tilde{q}}_{i} {\tilde{d}}_{i} ( R ) \qquad ( 8 )$$

Because ∥\tilde{q}∥| is constant, it results that:

$$S ( q , d ( R ) ) ∝ \frac{1}{‖ \tilde{d} ( R ) ‖} {\sum }_{f \vert {\tilde{q}}_{C ( f )} \neq 0 ⋀ f ∈ R} {\tilde{q}}_{C ( f )} {α}_{C ( f )} \qquad ( 9 )$$

where f denotes a feature in image I_{d}, fεR means that feature f is located inside the region R, and αᵢ is the IDF weight for word i.

From equation (9), it may be seen that the localized similarity may be represented as the sum of votes from individual feature points in database images. Therefore, for an arbitrary subrectangle, an inverted file may be used to accumulate the summation term in equation (9) for non-zero query words, and an integral image may be used to rapidly evaluate the term for an arbitrary subrectangle.

An integral image or histogram is an intermediary structure or representation known in the art which enables computation of histograms for sub-regions of an image in an efficient way. Specifically, in some embodiments, an integral image may be defined as a cumulative version of an input image—i.e., the value of the integral image at pixel (x,y) is the sum of all pixels inside the sub-rectangle [0,0,x,y]. Hence, an integral histogram may be similarly defined by accumulating histogram vectors. When these embodiments are employed, a sum of pixel values (or histograms) for an arbitrary sub-rectangle [x₁,y₁,x₂,y₂] may be computed by I(x₂,y₂)+I(x₁,y₁)−1(x₂,y₁)−1(x₁,y₂), where I is the intensity or histogram at each pixel in the image. As a consequence, the computation becomes constant as opposed to linear, which represents a significant improvement compared to the brute-force method of summing over pixel values. Accordingly, once an integral image or histogram has been computed for a database image, Local BoF histograms for sub-regions of the database image may be quickly computed.

For example, an integral image G_{q,d}(x,y)| of the summation term of equation (9) for query q and image d may be written as:

$${G}_{q , d} ( x , y ) = {\sum }_{f \vert {\tilde{q}}_{C ( f )} \neq 0 ⋀ f ∈ ( 0 , y , 0 , x )} {\tilde{q}}_{C ( f )} {α}_{C ( f )} \vert \qquad ( 10 )$$

Applying a binary TF histogram assumption, G_{q,d}(x,y)| may be simplified to the form:

$${G}_{q , d} ( x , y ) = {\sum }_{f \vert {\tilde{q}}_{C ( f )} \neq 0 ⋀ f ∈ ( 0 , y , 0 , x )} \frac{{α}_{C ( f )}^{2}}{{τ}_{d} ( C ( f ) )} \qquad ( 11 )$$

where τ_{d}(C(f)) is the TF word of C(f) in I_{d}, which distributes the contribution of multiple features f corresponding to the same visual word uniformly so as to promote the binary assumption of the global TF histogram of I_{d}.

In some embodiments, because the L₂ norm does not accumulate linearly, an approximation for ∥\tilde{d}(R)∥| may be used to evaluate the full similarity of equation (9). For very large vocabularies, the L₂ norm of a BoF vector may be approximated as the square root of the L₁ norm (which follows from the observation that, for large vocabularies, almost all TF histogram entries are either 1 or 0). Hence, in some embodiments, L2 norm ∥\tilde{d}(R)|₂| may be replaced with the L1 norm ∥\tilde{d}(R)₁|, which may be computed efficiently for any subrectangle using another integral image. In fact, the integral image H_{d}(x,y)| of |\tilde{d}(R)|₁ may be written as:

$${H}_{d} ( x , y ) = {\sum }_{f \vert f ∈ ( 0 , y , 0 , x )} \frac{{α}_{C ( f )}}{{τ}_{d} ( C ( f ) )} \vert \qquad ( 12 )$$

Consider now the case of L₁ norm. Again, let \tilde{q} and \tilde{d}| denote unnormalized TF-IDF weighted BoF histograms. Equation (4) may then be rewritten as follows:

$$S ( q , d ) = {\sum }_{i \vert {\tilde{q}}_{i} \neq 0 ⋀ {\tilde{d}}_{i} \neq 0} ( \frac{{\tilde{q}}_{i}}{\vert \tilde{q} \vert} + \frac{{\tilde{d}}_{i}}{\vert \tilde{d} \vert} - \vert \frac{{\tilde{q}}_{i}}{\vert \tilde{q} \vert} - \frac{{\tilde{d}}_{i}}{\vert \tilde{d} \vert} \vert ) \vert \qquad ( 13 )$$

And the localized similarity S(q, d(R)) may be written as follows:

$$S ( q , d ( R ) ) = {\sum }_{i \vert {\tilde{q}}_{i} \neq 0 ⋀ {\tilde{d}}_{i} ( R ) \neq 0} {α}_{i} ( \frac{{τ}_{q} ( i )}{\vert \tilde{q} \vert} + \frac{{τ}_{d ( R )} ( i )}{\vert \tilde{d} ( R ) \vert} - \vert \frac{{τ}_{q} ( i )}{\vert \tilde{q} \vert} - \frac{{τ}_{d ( R )} ( i )}{\vert \tilde{d} ( R ) \vert} \vert ) \vert \qquad ( 14 )$$

where τ_{q}(i) and τ_{d(R)}(i) are TFs of word i for q and d(R), respectively, and αᵢ is the IDF weight.

For large vocabularies, most TF histogram entries may be 0 or 1. Therefore, in some embodiments, the BoF may be approximated by its binary counterpart, where all non-zero entries are replaced by IDF weights. With this approximation, τ_{q}(i)=1 and τ_{d(R)}(i)=1 for all i such that \tilde{q}ᵢ≠0Λ\tilde{d}ᵢ≠0|. Breaking equation (14) into two cases, |\tilde{q}|>=∥\tilde{d}(R)∥| and |\tilde{q}|<|\tilde{d}(R)|, removes the absolute sign and the results of the two cases may be combined using a max operator as follows:

$$S ( q , d ( R ) ) = \frac{2}{max ( \vert \tilde{q} \vert , \vert \tilde{d} ( R ) \vert )} {\sum }_{i \vert {\tilde{q}}_{i} \neq ⋀ {\tilde{d}}_{i} ( R ) \neq 0} {α}_{i} \vert \qquad ( 15 )$$

Also, dropping the constant portion of the coefficient yields:

$$S ( q , d ( R ) ) ∝ \frac{1}{max ( \vert \tilde{q} \vert , \vert \tilde{d} ( R ) \vert )} {\sum }_{f \vert {\tilde{q}}_{C ( f )} \neq 0 ⋀ f ∈ R} {α}_{C ( f )} \vert \qquad ( 16 )$$

The simplification shown in equations (15) and (16) results in the factoring out of norms and a summation over features f. In some embodiments, equations (15) and (16) may be applied in an integral image-based framework. Specifically, the norm |\tilde{q}∥ is fixed with respect to R, while |\tilde{d}(R)| and the summation term may be computed efficiently for all R using the integral images. Similar to the L₂ case, the integral image G_{q,d}(x,y)| of the summation term for query q and image d may be written as:

$${G}_{q , d} ( x , y ) = {\sum }_{f \vert {\tilde{q}}_{C ( f )} \neq 0 ⋀ f ∈ ( 0 , y , 0 , x )} \frac{{α}_{C ( f )}}{{τ}_{d} ( C ( f ) )} \vert \qquad ( 17 )$$

where τ_{q}(i) denotes the TF histogram as in the L₂ case. The L₁ norm |\tilde{d}(R)| may be computed efficiently using the same integral image H_{d}(x,y)| of equation (12).

Generally speaking, the binary TF histogram assumption outlined above disregards some histogram information during a retrieval process. Accordingly, in some embodiments, some of the retrieved images may be re-ranked in a subsequent operation according to their exact histograms based on equation (14).

In certain embodiments, when forming integral images G_{q,d} and H_{d}|, multiple instances of a particular word may be spatially distributed without violating the binarization assumption. When the whole vote αᵢ is uniformly distributed to different instances (e.g., if there are K instances of word i, each instance gets a vote of αᵢ/K), arbitrarily selecting a particular word instance does not introduce a spatial bias and respects the binarization assumption. This is accomplished by the presence of τ_{d}(C(f)) in equations (11), (12) and (17).

In some embodiments, a coarse grid may be overlaid on the database images without affecting accuracy. This is in contrast to generic object category detection, where slight shifts and scalings of the window may affect the classification scores due to feature misalignment or the like. In some applications, a 80×80 or 160×160 grid may be generally sufficient for queries larger than 200×200 pixels. In the particular case where the grid is 80×80 and the image size is 480×640, for example, the memory or storage requirement for 1 million images is 96 MB, which is small compared to the size of the vocabulary and inverted file. Accordingly, the integral images G_{q,d} and H_{d}| may be defined on the grid, instead of at all pixels.

In certain embodiments, a goal-seeking or optimization process for finding a suitable sub-rectangle within an image may be used. One such process may be, for example, a “greedy search” algorithm as the one shown in Table I below:

TABLE I
Algorithm 1 Greedy Query Localization: (nₓ,n_{y})
is the grid width and height. M is the maximum iterations.
S(u,v,w,z) =: S(q,d(R)), R = (u,v,w,z).

(t,b,l,r) − (0,n_{y} − 1,0,nₓ − 1)
for i = 1 to M do

t′ − arg max_{j=0.....b-1} S(j,b,l,r) and b′ − arg max_{j=t′-1.....n}_{_{y}}₋₁ S(t′,j,l,r)
l′ − arg max_{j=0.....r-1} S(t′,b′,j,r) and r′ − arg max_{j=l′+1.....n}_{ₓ}₋₁ S(t′,b′,l′,j)
if (t,b,l,r) = (t′,b′,l′,r′) then

break

end if
(t,b,l,r) − (t′,b′,l′,r′)

end for
return R*− (t,b,l,r) and S − S(t,b,l,r)

In each iteration, individual coordinates in the order of (t, b, l, r) may be optimized and the iteration process may be stopped when the returned bounding rectangle in the current iteration is the same as in the previous iteration (or when a maximum iteration limit is reached). In applications discussed in more detail below, it has been found that, in some instances, this approach may find global optima in about 66% of the cases and that optimization process generally converges in less than 3 iterations.

In various embodiments, a goal-seeking or optimization process may or may not guarantee convergence to an absolute solution. For example, a goal-seeking process may exhaustively evaluate a solution space to ensure that the identified solution is the best available. Alternatively, the goal-seeking process may employ heuristic or probabilistic techniques that provide a bounded confidence interval or other measure of the quality of the solution. For example, a goal-seeking process may be designed to produce a solution that is within at least some percentage of an optimal solution, to produce a solution that has some bounded probability of being the optimal solution, or any suitable combination of these or other techniques.

### Local BoF-Based Image Retrieval

This portion of the specification provides techniques for fast, large scale, bag-of-features (BoF) retrieval. These techniques may employ the Local BoF model disclosed in the preceding section, or any combination of a Local BoF model with another image search mechanism. For example, in one embodiment, a method may evaluate a Local BoF search to re-rank images originally ranked using a Global BoF search.

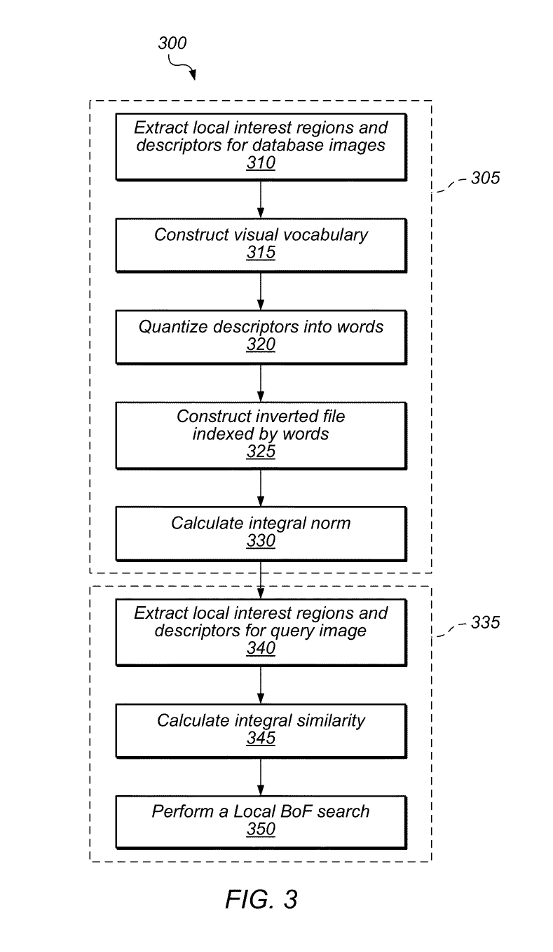

Referring now to FIG. 3, a flowchart of a BoF image retrieval method is depicted according to some embodiments. In some embodiments, method 300 may be performed, at least in part, by image analysis module 200 of FIG. 2. Method 300 may be generally split into two stages: training and indexing stage 305 and query stage 335. Although method 300 is illustrated showing query stage 335 immediately following training and indexing stage 305, it should be noted that these stages may be independently performed at different times and by different entities. In some implementations, training and indexing stage 305 may take place “offline” (or prior to a query), whereas query stage 335 may be executed “online” (or upon receipt of a query).

At 310 of training and indexing stage 305, method 300 may extract local interest regions and descriptors for some or all images in one or more databases. For example a Scale-invariant feature transform (SIFT) algorithm may be used to generate SIFT descriptors with 128 dimensions. However, any suitable feature extraction function may be used to generate descriptors with any number of dimensions. Further these images may be any type of digital image in any format, such as, for example, JPEG, JFIF, Exif, TIFF, RAW, PNG, GIF, BMP, CGM, SVG, PNS, JPS, etc. For example, an image may be a still image or a video image such as a frame of a video stream or the like.

At 315, method 300 may cluster the generated descriptors into discrete cluster centers. Any suitable clustering technique (e.g., k-means) may be employed. At 320, method 300 may quantize the cluster centers into visual words using any suitable quantization function, such that any descriptor may be mapped to its closest visual word. In one embodiment, the quantization function may transform a multi-dimensional cluster center into a one-dimensional, integer or scalar value. And at 325, method 300 may construct an inverted file including feature geometries indexed by the visual words.

In certain embodiments, the inverted file may be organized in a look-up table format as an array of lists, where each array element corresponds to a unique visual word and lists indices of database images containing that visual word. The array may be populated with location information for regions or sub-regions within each image where a particular visual word occurs. For example, location information may include pixel coordinates of rectangle(s) encompassing feature(s) represented by the visual word. Furthermore, pixel coordinates may be quantized in a grid overlaid onto the database image.

At 330, method 300 may store L₁ and/or L₂ norm integrals of database image BoFs. In some embodiments, these integral norm structures may be calculated based on equation (12), for example, using the inverted file discussed above. Additionally or alternatively, quantizer information may also be stored to quantize descriptors extracted from a query image at query stage 335.

At 340 of query stage 335, method 300 may extract local interest regions and descriptors in one or more query images. In some embodiments, a region or sub-region of the query image may be used as the query. The feature descriptors of the query image may be quantized in a manner similar to those of database images (at 320 of training and indexing stage 305) using stored quantizer information. At 345, method 300 may compute an integral similarly by evaluating distances (or similarities) between the query image and the database images using the inverted file. The integral similarity may be computed, for example, using equations (11) and/or (17). And at 350, method 300 may apply a Local BoF-based search to localize and rank results.

In certain embodiments, at 350, method 300 may select an arbitrary sub-region of a database image and compute a similarly score for that sub-region using a binary approximation. The search may then iteratively find a sub-region within the database image that has the highest similarity score for that image, for example, using the algorithm shown in Table I above. This process may be repeated for some or all images in the database. The Local BoF-based search may then repeat the similarity calculations for the selected sub-regions of each database image, this time without the binary approximation, and it may rank the database images using the latter scores.

In some embodiments, method 300 may replace post-processing operations that normally follow a Global BoF algorithm, thus “cooperating” with it by serving as a spatial verification alternative to RANSAC-based schemes or the like.

An illustrative Local BoF image retrieval algorithm configured to improve a search otherwise based on a Global BoF model is described in Table II below.

TABLE II
Algorithm 2 Local BoF Retrieval

/*---------------Offline-------------*/
Quantize local descriptors and construct the inverted file.
For each database image {Iᵢ}ᵢ=_{1,2...N} do

Compute H_{d}_{ᵢ} using Eq. 12.

end For
/*---------------Online--------------*/
Given the query BoF q, use the Global BoF method to rank the images.
For all top-K images {I_{T}_{ⱼ}}_{j=l.....K} on the ranked list do

Compute G_{q,d r}_{ⱼ} based on Eq. 11 or Eq. 17.
Compute R*(I_{T}_{ⱼ}) and S(I_{q},I_{T}_{ⱼ}) using Algorithm 1.

end For
for all top-K images I_{T}_{ₗ}.....I_{T}_{ₖ} on the ranked list do

Given R*(I_{T}_{ⱼ}), recompute S(I_{q},I_{T}_{ⱼ}) using the non-binarized BoF.

end For
Rerank the top K images based on S(I_{q},I_{T}_{ⱼ}).
return R*(I_{T}_{ⱼ}) and the reranked image list.

In the embodiment shown in Table II, a feature quantizer may be provided and feature descriptors may be indexed based on a quantizer. Indices may be organized into an inverted file as previously described. In an “offline” stage, integral norm images may be computed over a coarse uniform grid for both binary and full BoFs (represented by the first “for” loop of Table II). Later, in an “online” stage, a BoF histogram may be computed for the query image or region and database images may be first ranked based on a Global BoF algorithm. Then, a binarized Local BoF search (the second “for” loop of Table II) may be performed to estimate an optimal rectangle for each database image, and a non-binarized Local BoF search (the third “for” loop of Table II) may be used to compute final similarity scores for each rectangle. Finally, the top K images may be re-ranked based on the computed similarity scores for its respective rectangle.

In certain embodiments, the Global BoF method employed in Table II may be replaced with any other search mechanism configured to rank, pre-rank, or otherwise reduce the amount of relevant database images to a manageable number. Although the algorithm of Table II indicates a “re-ranking” of “top K images,” in alternative embodiments a ranking of any number of images—e.g., all images in an image database—may be performed.

In some embodiments, a Local BoF model as discussed above may be further extended by imposing a weak spatial consistency constraint using a Local Spatial Pyramid Model (LSPM). Using the LSPM extension to the Local BoF model, a query region may be decomposed into different spatial quantization levels P×P, where P=1, 2 . . . . In each pyramid level, the similarity vote may be computed for each grid cell in this spatial quantization and averaged, and the similarities at some or all pyramid levels may also be averaged to obtain the pyramid-based Local BoF similarity.

For example, for data sets such as the Oxford Building data set (discussed below), where objects are mostly upright in the images, more levels of the spatial pyramid may be more discriminative and hence may result in better average precision. In some embodiments, P=2 may be a good tradeoff between accuracy and complexity.

### Applications

Embodiments of methods and systems disclosed herein may provide Local BoF search techniques suitable for use in image retrieval, categorization, or the like. These techniques may be used as building blocks in various computer vision and imaging applications including, for example, object recognition and categorization, 3D modeling, mapping, navigation, gesture interfaces, etc.

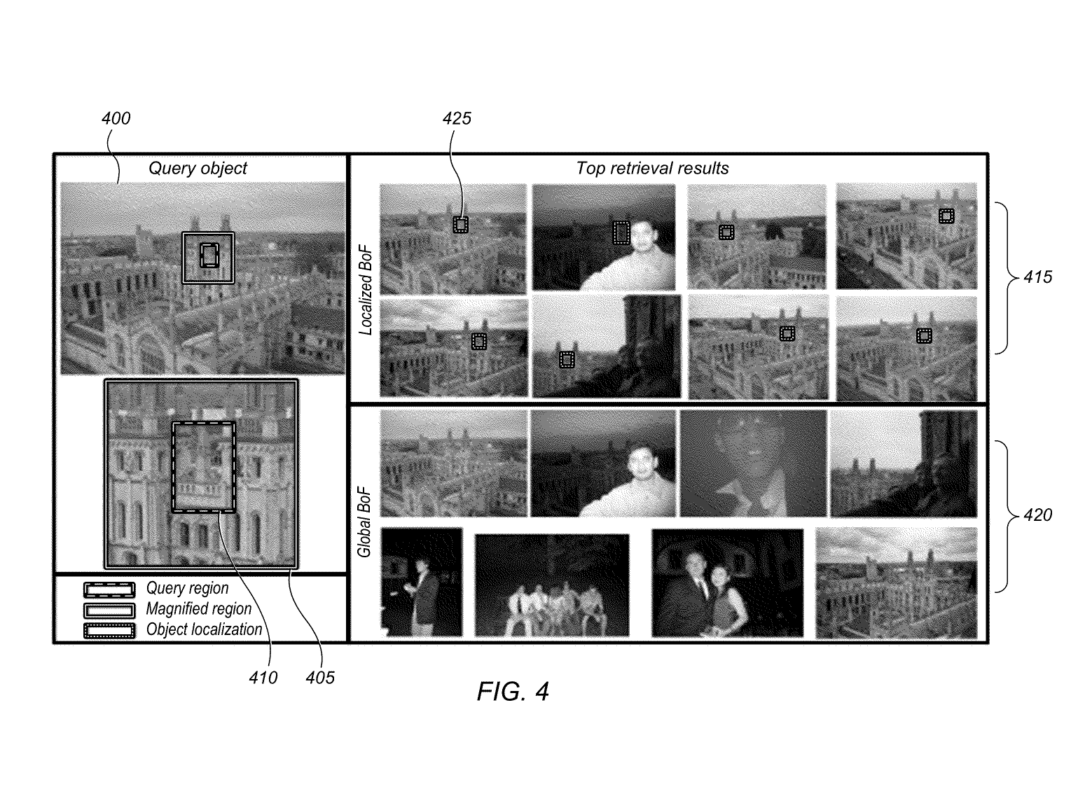

For example, FIG. 4 shows images illustrating example results obtained using a Local BoF method according to some embodiments. A magnified portion 405 of query image 400 shows a query region 410 (small rectangle) on the left-hand side to illustrate that, in some embodiments, a sub-region 410 of query image 400 may be used to perform the search. On the right-hand side, retrieval results obtained with a Local BoF search are depicted in bracket 415 (top), and results obtained with a Global BoF search are depicted in bracket 420 (bottom). It may be noted that the results shown in bracket 415 display images that are more similar to query region 410 and/or query image 400 than the results shown in bracket 420.

Still referring to FIG. 4, the results of Local BoF search also include, for each image, location information 425 of the regions that are most similar to query region 410. Although only one region is shown for each image, in alternative embodiments, two or more regions may be found. This is in contrast with the results of Global BoF search 420, which cannot return bounding boxes and would need additional computationally expensive processing (e.g., RANSAC) to localize objects of interest.

For sake of comparison with other methods, a Local BoF-based search was applied to two image retrieval data sets: a University of Kentucky data set (Ukbench) and an Oxford Building (5K) data set (Oxbuild). Ukbench contains 10,200 images of 2,550 objects, where each object occurs in exactly four images. The evaluation metric is the average number of correct top-4 images for all 10,200 queries. Oxbuild contains 5,062 images and 55 standard test queries of 11 landmarks. Performance was evaluated as the mean average precision (mAP) score.

The Local BoF embodiment used in the comparisons comprised affine invariant region detection, SIFT description, and hierarchical quantization methods. This Local BoF embodiment also used a fixed grid size of 80×80 pixels and performed re-ranking for top K images (where K=400 for Oxbuild and K=20 for Ukbench).

Comparison with Oxbuild

In the comparison using the Oxbuild dataset, two types of “query resize” experiments were performed: (1) performance with respect to the resize ratio to the original query rectangle, i.e., test mAP values by varying the standard 55 query rectangles by fixing their center points and scales them uniformly by a set of constant factors ranging from 0 to 1; and (2) performance with respect to the area (pixel size) of query subrectangle, i.e., test mAP values by choosing fixed-size query subrectangles (the same number of pixels for all queries) with the same center and aspect ratio to the original query rectangles. It should be noted that query rectangles were resized instead of the underlying query images.

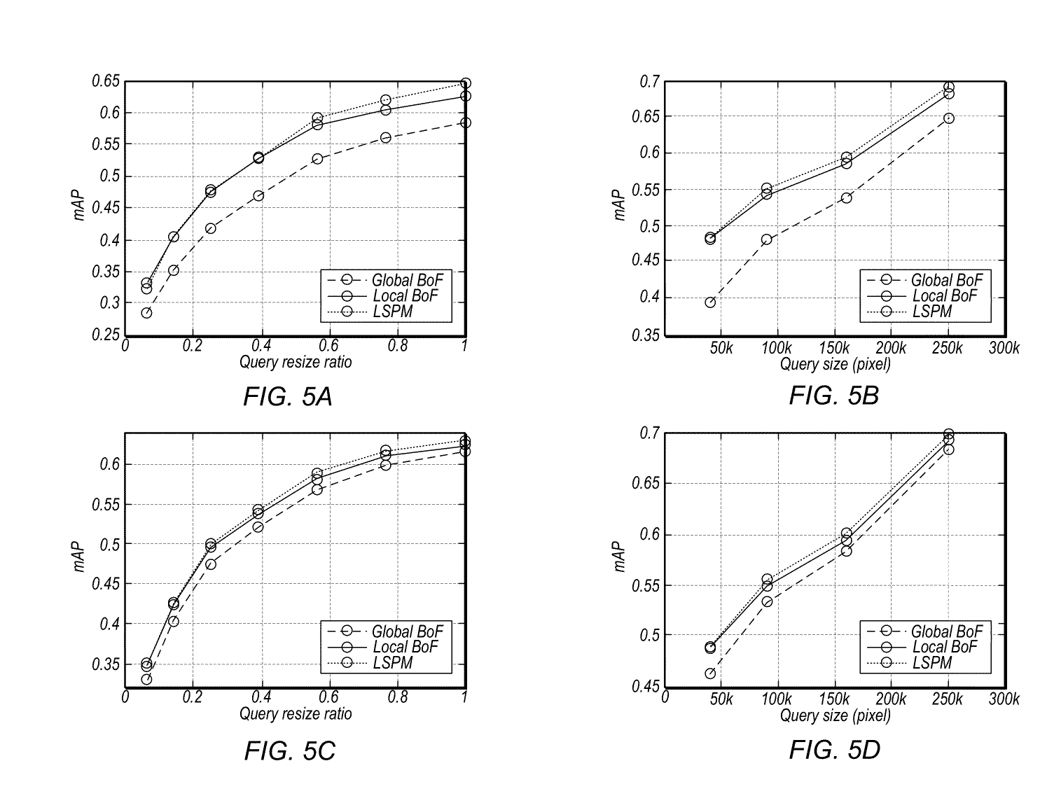

FIGS. 5A-D show example results of comparisons among Local BoF, Global B of, and LSPM extension of the Local BoF method according to some embodiments. Specifically, FIG. 5A illustrates a comparison with respect to the query size in ratios to the original query regions (the L₁ case) and FIG. 5B graph illustrates the comparison with respect to the query size in pixels (the L₁ case). FIG. 5C illustrates a comparison with respect to the query size in ratios to the original query regions (the L₂ case), and FIG. 5D illustrates the comparison with respect to the query size in pixels (the L₂ case).

FIGS. 5A and 5B show comparison results of experiments for the L₁ case. It may be seen that these experiments consistently outperform the Global BoF approach, improving mAP on average by 12.7% across all query resize ratios and 13.6% across all absolute query subrectangle sizes (pixels). In general, LSPM (level 2) showed better performance than Local BoF for larger scales due to its better discriminative power. For smaller queries, the advantage of using LSPM is not as clear due to the sparseness of the query features. Surprisingly, as seen in FIG. 5B, the smaller the absolute query size, the more benefit is observed using Local BoF algorithms.

FIGS. 5C and 5D show the same experiments for the L₂ case. Similar consistent improvement may be observed over the baseline Global BoF method, but the improvement is less than the L₁ case on average by 4.2% across all query resize ratios and 3.8% across all absolute query sizes (pixels). In comparison with previous approaches, mAP of the Local BoF method using the original 55 queries is 0.647, which is significantly better than the L₁ Global BoF (0.582) and L₂ Global BoF (0.618). Moreover, the Local BoF obtained almost identical result to the Global BoF with RANSAC-based re-ranking, while being significantly faster than RANSAC-based verification. For example, the Local BoF method may be applied to thousands of the database images in less than 50 ms during retrieval time.

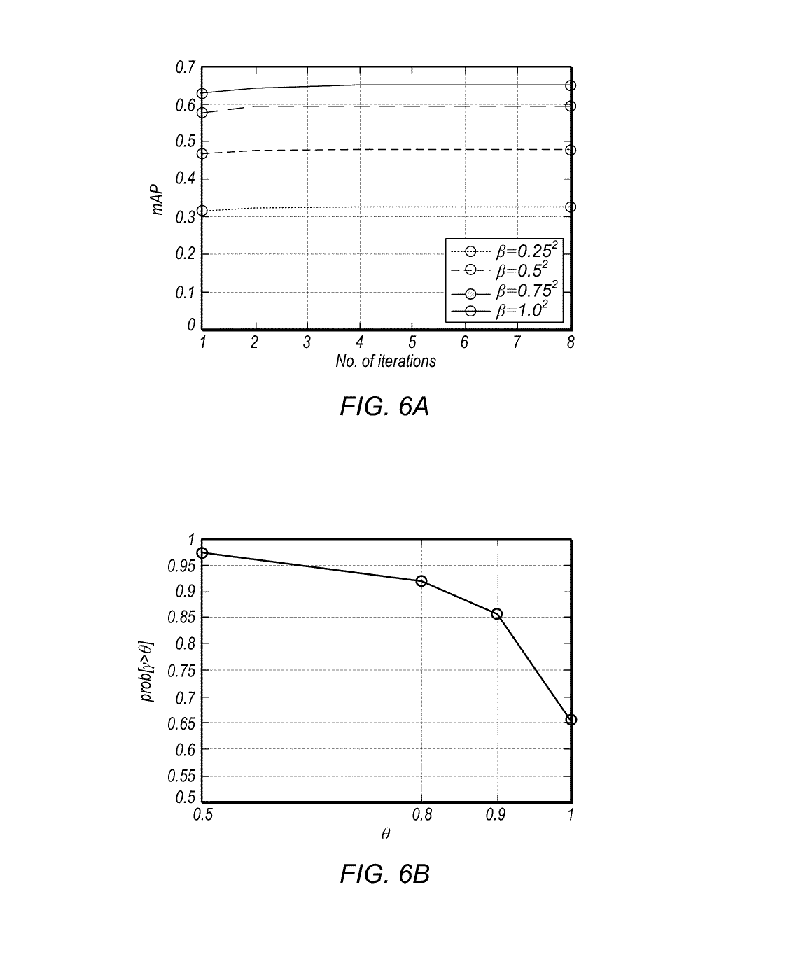

In addition to serving as a data set for the comparisons outlined above, Oxbuild was used to determine the number of greedy iterations needed for convergence during a local BoF search process. FIGS. 6A and 6B show graphs relating to that analysis. Specifically, FIG. 6A shows mAP with respect to the number of greedy iterations, where β denotes the query resize ratio, and the graph on the right-hand side shows a comparison of the greedy solution with the global optima Prob(y>θ) computed as the percentage of localization tasks where the greedy solution rectangle overlaps with the global optimum rectangle when changing the area overlap ratio threshold θ.

From FIG. 6B, it may be seen that retrieval performance improves with increasing iterations, but the improvement slows significantly after 2 iterations. Surprisingly, all of the optimization for 22,000 test images over 55 queries coverage in less than 4 iterations. For about 95% images, the process converges in only 2 iterations. As such, FIG. 6B validates proximity of the Local BoF to the global optimum when changing the area overlap ratio γ to a globally optimum rectangle. The area overlap ratio γ(R₁, R₂) between two rectangles R₁ and R₂ may be defined as:

$$γ = \frac{A ( {R}_{1} ⋂ {R}_{2} )}{A ( {R}_{1} ⋃ {R}_{2} )} ,$$

where A(Q) is the area of region Q.

Note that in about 66% of cases out of 22,000 total localization tasks, the tested Local BoF algorithm achieved the exact global optimum.

As shown in Table III below, the retrieval performance using a greedy-based approach and the globally optimum-based approach (branch-and-bound or brute-force search) were computed with respect to different query resize ratios β. From this table it appears that, in some embodiments, use of a greedy search does not result in significant degradation of mAP.

TABLE III

| mAP | β = 0.25² | β = 0.5² | β = 0.75² | β = 1.0² |
|---|---|---|---|---|
| Greedy solution | 0.322 | 0.476 | 0.591 | 0.647 |
| Global optimum | 0.329 | 0.481 | 0.591 | 0.644 |

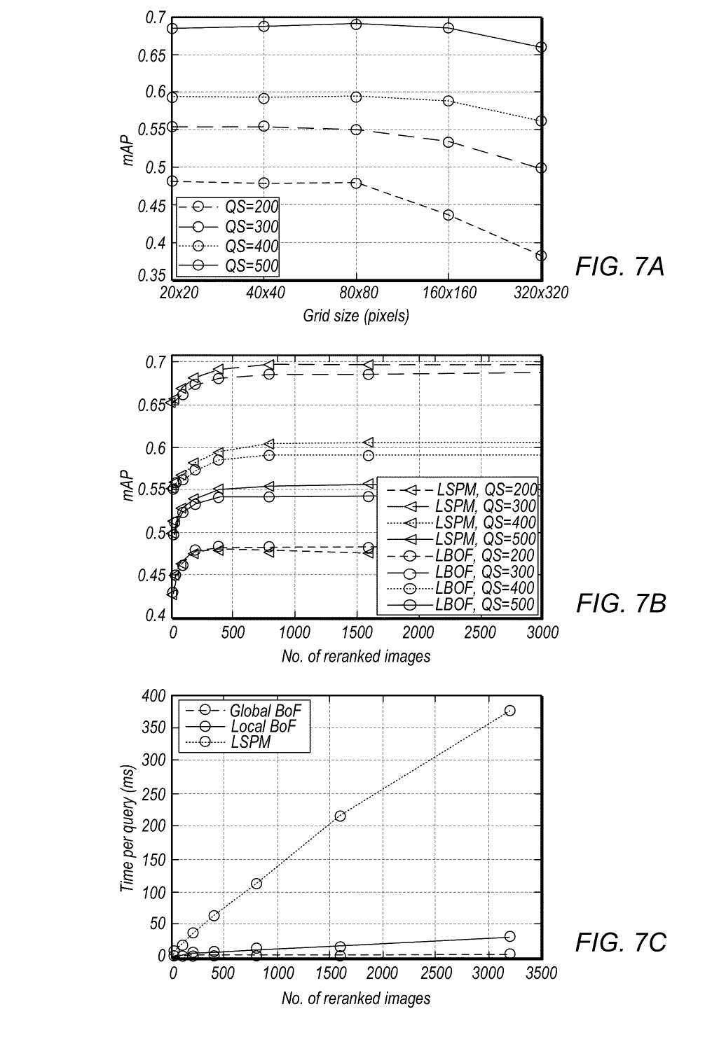

In addition to the foregoing, Oxbuild was also used to analyze Local BoF model parameters. FIGS. 7A-C show graphs of the example results of a Local BoF parameter analysis. Specifically, FIG. 7A shows mAP with respect to grid size (grid spacing in pixels) using the LSPM extension of a Local BoF algorithm, where “QS=n” means the query region size is n×n pixels. FIG. 7B shows mAP with respect to the number of reranked images, where “LBOF” stands for Local BoF and ‘QS=n’ means the query size is n×n pixels. Finally, FIG. 7C shows the query time comparison with respect to the number of re-ranked images.

FIG. 7A illustrates the effect of changing the grid size (grid spacing) from 20×20 to 320×320, for a range of query sizes. It may be observed that the retrieval performance of the LSPM tends to be increasing and leveling off with smaller grid sizes. For larger grid sizes, the degradation in accuracy is more significant for small-size queries. This indicates that more precise localization may be achieved using smaller grids, and when the query size is smaller or similar to the grid size, LSPM may become too sparse.

FIG. 7B illustrates the mAP of the Local BoF and the LSPM with respect to K (the number of top images to rank or re-rank) and query size. It may be noted that all curves level off with increasing number of re-ranking images. The graph also shows a consistent mAP improvement of when moving from K=25 to K=800, where the LSPM results improve by 9.7% and the Local BoF results improve by 8.4% on average. This indicates robustness with respect to K. Also, for most query sizes, LSPM outperformed the Local BoF by about 2% on average but the LSPM resulted in a lower mAP than the local BoF for the smallest query due to the relatively coarser grid size (80×80).

In the foregoing applications and experiments, the tested BoF method stored feature locations (x, y) (with 1 byte per feature coordinate) as the geometric information in the inverted file, but it did not store affine geometry parameters. Indexing 1 million images, averaging 500 features per image, used about 1 GB. In addition to the inverted file, the tested BoF method stored L₁ or L₂ norm integrals of all database image BoFs. If each image has 48 grids, storing each integral requires 100 bytes. For 1 million images, this only amounted to 100 MB, which is small compared to the size of the inverted file. Typically, the average query (or retrieval) time (ignoring the query feature extraction) for reranking the top 3200 images was less than 30 ms compared to around 5 ms for the Global BoF approach. Accordingly, the tested Local BoF method is capable of spatially verifying, reranking, and localizing objects for 100 k images in less than 1 second, which is significantly faster than RANSAC-based spatial verification for the same number of reranking images.

Comparison with Ukbench

Similar applications and experiments were also performed using the Ukbench data set. Each of the original query regions (entire image regions) was resized by fixing its center to the center of the original image since there are no query regions are given. A hierarchical k-means (HKM) algorithm and the SIFT features were used to build a hierarchical vocabulary.

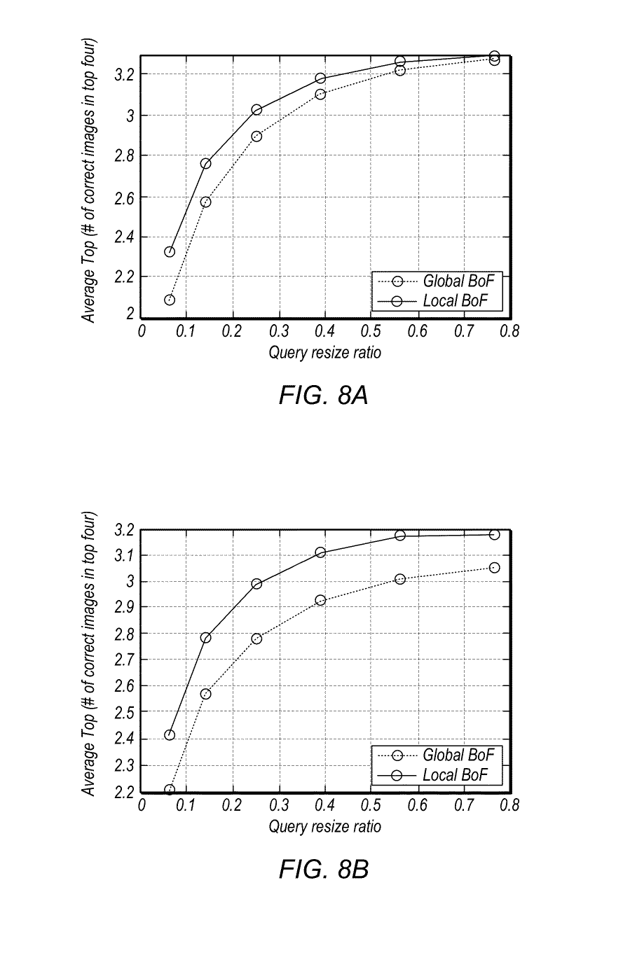

FIGS. 8A and 8B show example results of comparisons among Local BoF and Global B of using the Ukbench data set according to some embodiments. (FIGS. 8A and 8B are analogous to those shown in FIGS. 6A and 6B, respectively, for the Oxbuild data set.) The improvement of the tested Local BoF method over the Global BoF method is most significant for smaller queries, i.e., in general the smaller the query the more improvement we achieved. Specifically, the absolute improvement of the top-4 rate is 0.19 for the L₁ case and 0.21 for the L₂ case which are significant considering the strict true positive criterion used for the data set. For larger queries, the tested Local BoF method achieved relatively smaller improvement in retrieval because most of the images in this data set are close-up shots of objects. Comparing the L₁ and L₂ cases, the improvement for L₂ is more consistent over all query sizes.

The various methods as illustrated in the figures and described herein represent example embodiments of methods. The methods may be implemented in software, hardware, or a combination thereof. The order of method may be changed, and various elements may be added, reordered, combined, omitted, modified, etc. Various modifications and changes may be made as would be obvious to a person of ordinary skill in the art having the benefit of this specification. It is intended that the invention embrace all such modifications and changes and, accordingly, the above description to be regarded in an illustrative rather than a restrictive sense.

1-20. (canceled)

21. A method implemented by one or more computer systems, the method comprising:
determining whether a query image corresponds to one or more of a set of images by:
determining whether one or more features of the query image correspond to one or more features in respective images in the set of images; and
determining whether spatial locations of the one or more features of the query image are spatially consistent with spatial locations of the one or more features of the respective images in the set of images, the spatial locations describing positioning of respective said features within a respective said image; and
returning a result of the determining of whether the query image corresponds to one or more of the set of images.

22. A method as described in claim 21, wherein the one or more features of the query image and the images in the set of images are represented using one or more respective bag-of-features histograms.

23. A method as described in claim 22, wherein each of the bag-of-features histograms are parameterized based on corresponding sub-rectangles within the query image and the images in the set of images, respectively.

24. A method as described in claim 23, wherein each of the sub-rectangles within the query image.

25. A method as described in claim 21, wherein the result is a ranked list based on correspondence of the query image to respective images in the set of images.

26. A method as described in claim 25, wherein the ranked list is formed based at least in part on an integral norm histogram calculated over a grid of regions and an integral similarity histogram calculated over the grid of regions.

27. A method as described in claim 21, further comprising:
mapping visual words to descriptors of local interest regions for each of a plurality of images, the local interest regions defined such that at least one part of a corresponding said image is not included in the region; and
constructing an inverted file indexed by the visual words, each of the visual words having a corresponding indication of location of the local interest region within the corresponding said image.

28. A method as described in claim 27, wherein the determining whether spatial locations of the one or more features of the query image are spatially consistent with spatial locations of the one or more features of the respective images in the set of images is performed using the inverted file.

29. A method implemented by one or more computer systems, the method comprising:
mapping visual words to descriptors of local interest regions for each of a plurality of images, the local interest regions defined such that at least one part of a corresponding said image is not included in the region; and
constructing an inverted file indexed by the visual words, each of the visual words having a corresponding indication of location of the local interest region within the corresponding said image.

30. A method as described in claim 29, further comprising extracting the descriptors from the plurality of images, clustering the descriptors into cluster centers, and quantizing the cluster centers into the visual words to perform the mapping.

31. A method as described in claim 30, wherein the quantizing further comprises associating a unique integer index with each said cluster center.

32. A method as described in claim 30, wherein the local regions of interest are arranged within a grid of rectangles.

33. A method as described in claim 29, further comprising calculating an integral norm histogram for each of the plurality of images based at least in part on the inverted file.

34. A method as described in claim 29, wherein the descriptors includes Scale-Invariant Feature Transform (SIFT) descriptors.

35. A method as described in claim 29, wherein the inverted file comprises a look-up table having a plurality of array elements, each said array element corresponding to a unique said visual word and lists indices of the plurality of images containing the unique said visual word, the look-up table populated with the location information for a sub-region within each said image that corresponds to a given said visual word.

36. A system implemented by one or more computer systems, the system configured to perform operations comprising:
determining whether a query image corresponds to one or more of a set of images by:
determining whether one or more features of the query image correspond to one or more features in respective images in the set of images; and
determining whether spatial locations of the one or more features of the query image are spatially consistent with spatial locations of the one or more features of the respective images in the set of images, the spatial locations describing positioning of respective said features within a respective said image; and
returning a result of the determining of whether the query image corresponds to one or more of the set of images.

37. A system as described in claim 36, wherein the one or more features of the query image and the images in the set of images are represented using one or more respective bag-of-features histograms.

38. A system as described in claim 37, wherein each of the bag-of-features histograms are parameterized based on corresponding sub-rectangles within the query image and the images in the set of images, respectively.

39. A system as described in claim 37, wherein the computer system is configured to perform operations further comprising:
mapping visual words to descriptors of local interest regions for each of a plurality of images, the local interest regions defined such that at least one part of a corresponding said image is not included in the region; and
constructing an inverted file indexed by the visual words, each of the visual words having a corresponding indication of location of the local interest region within the corresponding said image.

40. A system as described in claim 39, wherein the determining whether spatial locations of the one or more features of the query image are spatially consistent with spatial locations of the one or more features of the respective images in the set of images is performed using the inverted file.
